(19) United States
(12) Patent Application Publication
(10) Pub. No.: US 2010/0164859 A1
(43) Pub. Date: Jul. 1, 2010

(54) FRAME, LIQUID CRYSTAL DISPLAY EMPLOYING THE FRAME, AND METHOD FOR MANUFACTURING THE FRAME

(75) Inventor: HSIEH-TING HUANG, Miao-Li (TW)

Correspondence Address: PCE INDUSTRY, INC.;ATT. Steven Reiss, 288 SOUTH MAYO AVENUE, CITY OF INDUSTRY, CA, 91789, US

(73) Assignee: INNOLUX DISPLAY CORP., Miao-Li County (TW)

(21) Appl. No.: 12/650,502

(22) Filed: Dec. 30, 2009

(30) Foreign Application Priority Data
Dec. 31, 2008 (CN) 200810306746.X

(51) Int. Cl. G09G 3/36; H04N 5/64; B21D 43/28

(52) U.S. Cl. 345/102; 348/794; 72/324; 348/E05.128

(57) ABSTRACT

An exemplary frame includes sidewalls and rims extending substantially perpendicularly from the sidewalls, respectively. The rims are arranged end to end in turn, thereby defining an opening therebetween. The sidewalls are portions of a single bent metallic strip with two ends thereof connected together. A liquid crystal display employing the frame and a method for manufacturing the frame are also provided.

### BACKGROUND

1. Technical Field

The present disclosure generally relates to display technology, and particularly to a frame employed in a liquid crystal display (LCD) and a method for manufacturing the frame.

2. Description of Related Art

A typical LCD has the advantages of portability, low power consumption and low radiation, and has been widely used in various portable information products such as notebooks, personal digital assistants (PDAs), video cameras and the like. Conventionally, an LCD includes a display panel and a backlight module providing light to the display panel. The display panel and the backlight module are received and fixed by a metallic frame and a plastic frame which are attached to each other.

Referring to FIGS. 8-10, in a frequently used method for manufacturing a metallic frame, coiled metallic sheet stock is cut to form a rectangular metallic sheet (not shown). Four corners of the rectangular metallic sheet are punched and trimmed to form four outer sides 12 around a rectangular plane portion 11, as shown in FIG. 8. The four outer sides 12 are then bent perpendicular to the rectangular plane portion 11, as shown in FIG. 9. A center portion of the rectangular plane portion 11 is then punched to form a display view window 14, as shown in FIG. 10. Finally, each two adjacent outer sides 12 are joined together by laser welding. Thereby, the metallic frame 10 is formed, as seen in FIG. 10.

In the above-described process, the center portion of the rectangular plane portion 11 is removed by punching and trimming to form the display view window 14. The removed portion of the rectangular plane portion 11 is about two-thirds the size of the entire rectangular metallic sheet, and the removed portion needs to be discarded or recycled for use. Thus, the process involves considerable waste material. Accordingly, the metallic frame 10 and the LCD employing the metallic frame 10 are somewhat costly.

What are needed, therefore, are a frame, an LCD employing the frame, and a method for manufacturing the frame, which can overcome the described limitations.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views, and all the views are schematic.

FIG. 1 is an isometric, exploded view of a first embodiment of an LCD, the LCD including a frame.

FIGS. 2-4 are isometric views showing steps of an exemplary method for manufacturing a frame such as, for example, that of FIG. 1.

FIG. 5 is an isometric view of part of a precursor of a frame of an alternative embodiment of the first embodiment, the precursor not yet folded to form the frame.

FIG. 6 is an isometric view of part of a precursor of a frame of a second embodiment of an LCD, the precursor not yet folded to form the frame.

FIG. 7 is an isometric view of part of a precursor of a frame of a third embodiment of an LCD, the precursor not yet folded to form the frame.

FIGS. 8-10 are isometric views showing steps of a commonly used method for manufacturing a frame of an LCD.

### DETAILED DESCRIPTION

Reference will now be made to the drawings to describe various embodiments in detail.

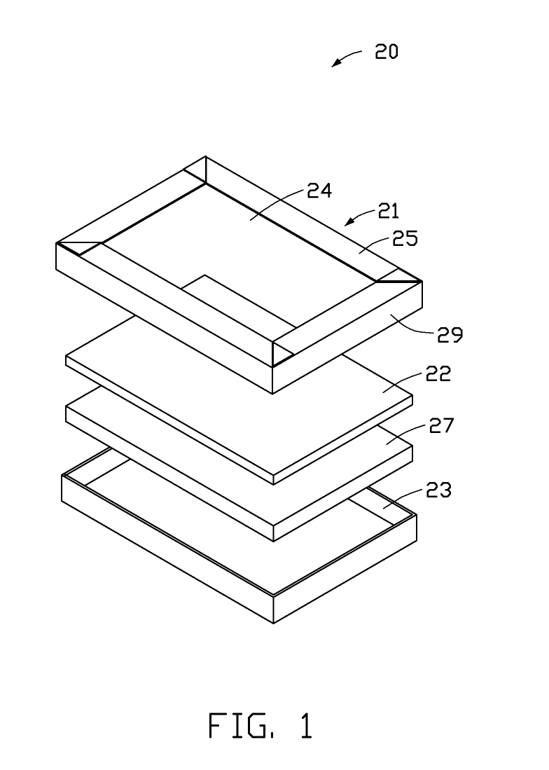

Referring to FIG. 1, an LCD 20 includes a first frame 21, a display panel 22, a second frame 23, and a backlight module 27. The first frame 21 and the second frame 23 cooperatively receive and fix the display panel 22 and the backlight module 27. The first frame 21 may be made of metallic material, and the second frame 23 may be made of plastic material. The first frame 21 includes four beams continuously arranged end to end. The four beams define a rectangular opening 24. The opening 24 may act as a display view window of the LCD 20. Each beam may include a sidewall 29 and a rim 25 extending perpendicularly from the sidewall 29.

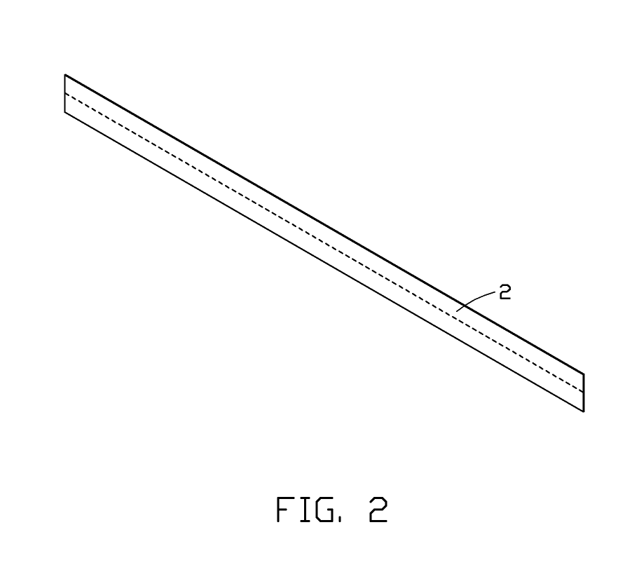

Referring also to FIGS. 2-4, these show steps of an exemplary method for manufacturing a frame, such as, for example, the first frame 21. The method is as follows:

In step S1, a rectangular metallic strip 2 is formed. The metallic strip 2 may be cut from coiled metallic sheet stock (not shown). Referring to FIG. 2, the rectangular metallic strip 2 is substantially the same length as a sum of lengths of the four sidewalls 29. The rectangular metallic strip 2 has a uniform transverse width substantially the same as a sum of a height of one of the sidewalls 29 and a transverse width of one of the rims 25.

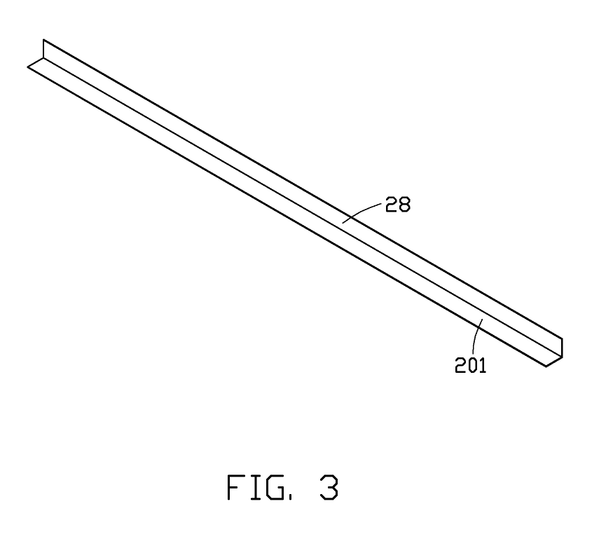

In step S2, an elongated first plate 201 and an elongated second plate 28 are formed by rolling the metallic strip 2. The second plate 28 perpendicularly adjoins the first plate 201, as shown in FIG. 3. The second plate 28 has a uniform transverse width which is the same as a height of one of the sidewalls 29. Put another way, the second plate 28 has a uniform transverse width substantially the same as a thickness of the display panel 22.

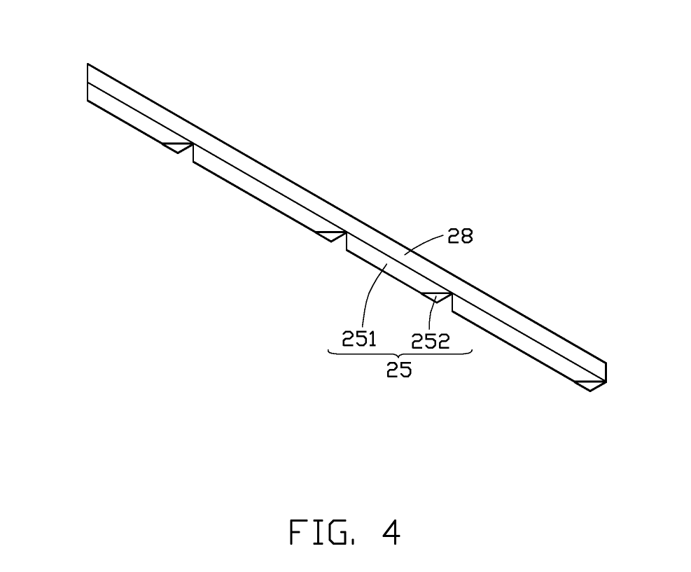

In step S3, the rims 25 are formed by punching, cutting and/or stamping the first plate 201. Referring to FIG. 4, each rim 25 includes a first portion 251, and a second portion 252 projecting from the first portion 251. The first portion 251 is isosceles trapezoidal, and a longer inner edge of the first portion 251 adjoins the second plate 28. The second portion 252 is isosceles triangular, and an inmost, oblique edge of the second portion 252 adjoins one of the two equal end edges of the first portion 251. The second portion 252 is offset slightly down from the first portion 251, and substantially parallel to the first portion 251. Thus, the first portion 251 and the second portion 252 cooperatively define what is substantially a right trapezoid. The second portion 252 is formed by stamping a precursor of the corresponding rim 25 in a vertically downward direction perpendicular to the first portion 251. The first portions 251 and the second portions 252 of the rims 25 are arranged alternately along a length of the combined first and second plates 201, 28. Thus, an isosceles triangular cutout is defined between each two adjacent rims 25.

In step S4, the sidewalls 29 are formed by bending the second plate 28 where each two adjacent rims 25 meet, and then joining each two adjacent rims 25 together by laser welding. A height of each sidewall 29 substantially equals a thickness of the display panel 22. A length of each sidewall 29 equals a length of the longer inner edge of the first portion 251 of the corresponding rim 25. Due to the projection of each second portion 252 from the corresponding first portion 251, when the second plate 28 is bent, the second portion 252 of each rim 25 closely overlaps a part of the first portion 251 of the adjacent rim 25. The overlapping portions of each two adjacent rims 25 are then connected by laser welding. The rectangular opening 24 is thus formed, surrounded by the four rims 25.

In step S5, the two ends of the second plate 28 are connected, by laser welding for example. Thereby, the first frame 21 is formed.

In summary, the first frame 21 is formed from the rectangular metallic strip 2. Compared with metallic frames manufactured by other methods, providing the rectangular opening 24 of the first frame 21 requires no significant removal of metallic material from a base piece of metallic material. That is, a great majority of the rectangular metallic strip 2 is utilized, reducing or eliminating waste of the metallic material. Accordingly, the cost of manufacturing the first frame 21 and the LCD 20 can be lowered.

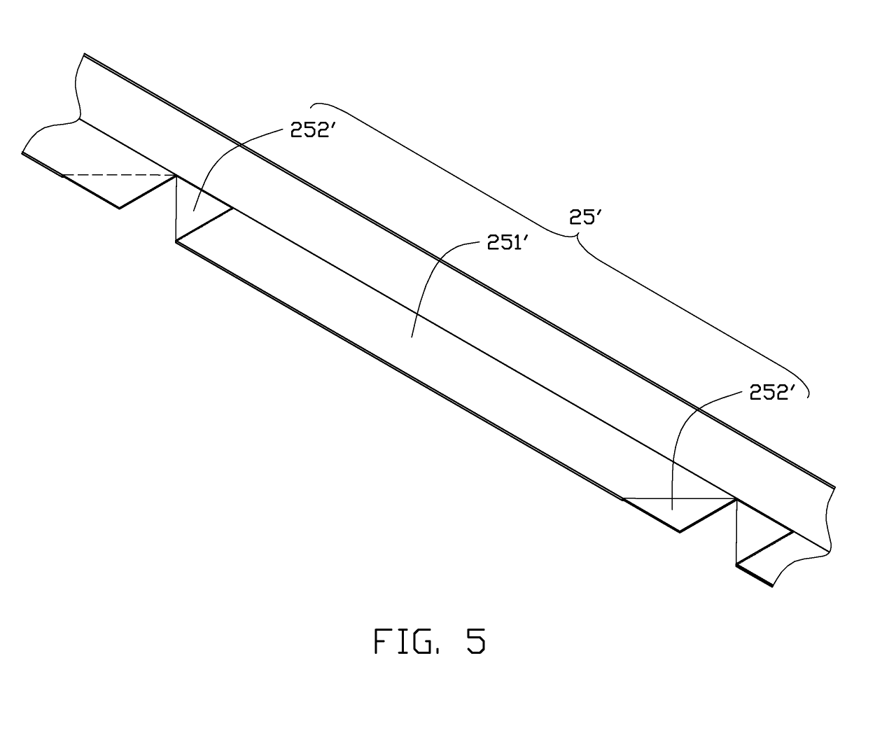

Furthermore, referring to FIG. 5, in an alternative embodiment of the first embodiment, each of rims 25′ of a first frame (not shown) can include a first portion 251′ and two second portions 252′ respectively extending from two ends of the first portion 251′. A thickness of each of the second portions 252′ is less than that of the first portion 251′, and preferably half of that of the first portion 251′. One second portion 252′ of each rim 25 overlaps one second portion 252′ of an adjacent rim 25. Thus, when two adjacent second portions 252′ of adjacent rims 25 overlap and are jointed together, the combination of the overlapped second portions 252′ is substantially coplanar with each of the corresponding first portions 251′.

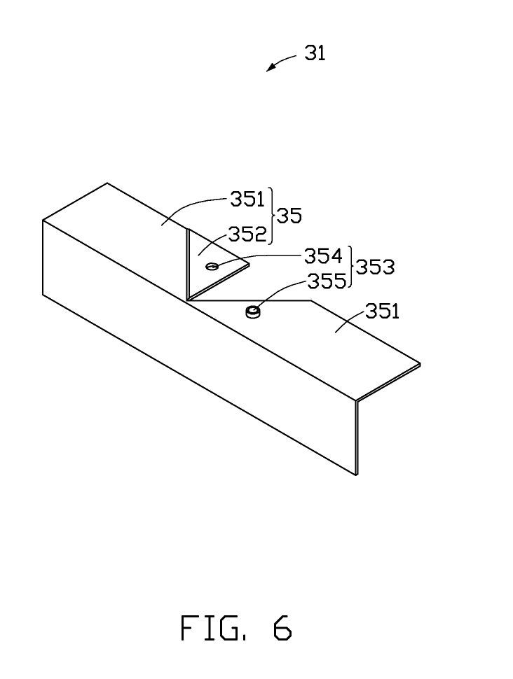

Referring to FIG. 6, this shows part of a precursor of a first frame 31 of a second embodiment of an LCD, the precursor not yet folded to form the first frame 31. The LCD of the second embodiment differs from the LCD 20 only in that the first frame 31 of the LCD of the second embodiment further includes a plurality of locking units 353.

Each locking unit 353 includes a positioning hole 354 and a protrusion 355. The positioning hole 354 is a circular through hole defined in a second portion 352 of each of rims 35 of the first frame 31, and is formed by punching the second portion 352. In this embodiment, the protrusion 355 is in the form of a cylindrical collar, corresponding to the positioning hole 354. The protrusion 355 is formed at a first portion 351 of an adjacent rim 35 by punching the first portion 351 of the adjacent rim 35. An axis of the protrusion 355 is parallel to an axis of the positioning hole 354. Each two adjacent rims 35 are fixed to each other by the protrusion 355 of one rim 35 being engagingly received in the positioning hole 354 of the other rim 35. Thus, connecting each two adjacent rims 35 via the locking unit 353 is simple, and assembling the LCD of the second embodiment is convenient.

In alternative embodiments, the positioning hole 354 can instead be a blind hole or a depressed portion corresponding to the respective protrusion 355. In such case, a height of the corresponding protrusion 355 is less than or equal to a depth of the blind hole or depressed portion. Furthermore, the positions of the positioning hole 354 and the protrusion 355 in each locking unit 353 can be exchanged. That is, the positioning hole 354 can be disposed at the first portion 351 of one of the rims 35, and the protrusion 355 can be disposed at the second portion 352 of the adjacent rim 35.

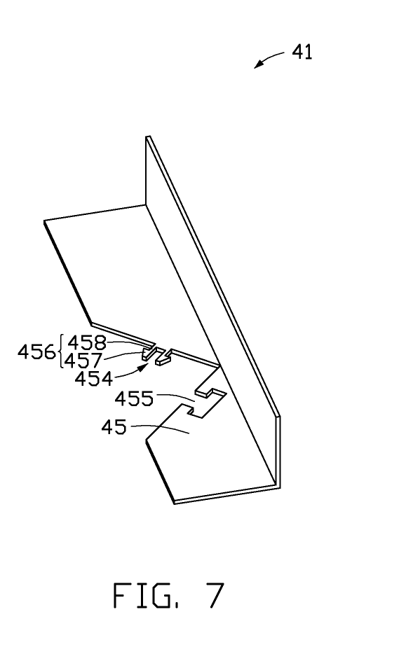

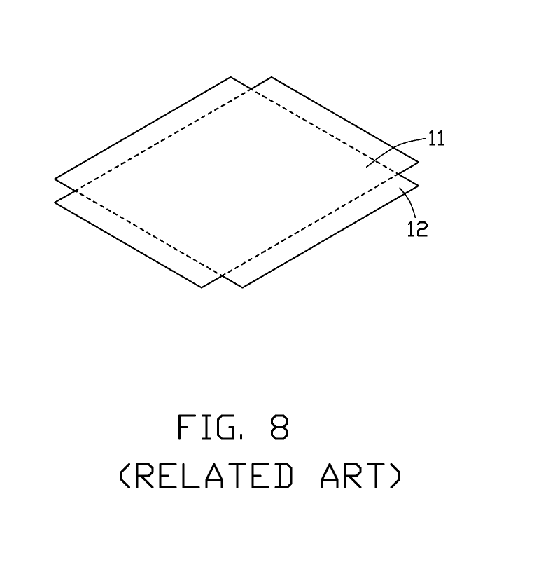

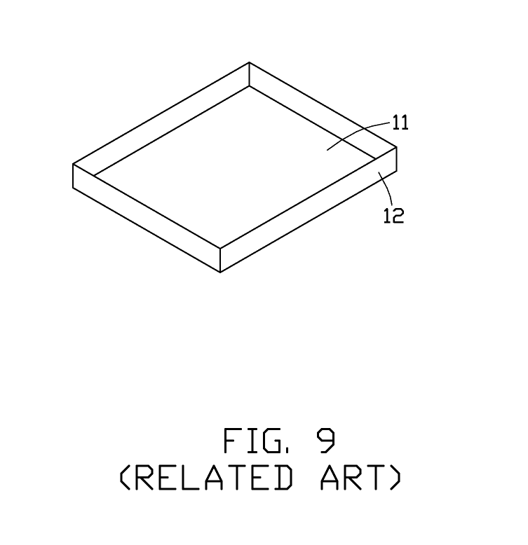

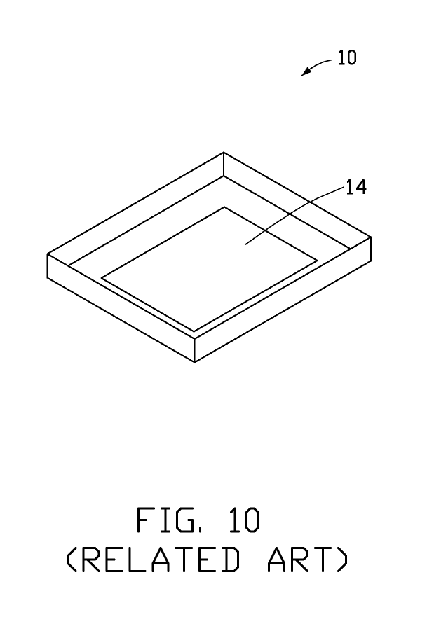

Referring to FIG. 7, this shows part of a precursor of a first frame 41 of a third embodiment of an LCD, the precursor not yet folded to form the first frame 41. The LCD of the third embodiment differs from the LCD of the second embodiment only in that each of rims 45 of the first frame 41 of the LCD is generally isosceles trapezoidal, all portions of all the rims 45 are coplanar with one another, and a generally isosceles triangular cutout (not labeled) is defined between each two adjacent rims 45. Two generally symmetrically opposite end edges of each two adjacent rims 45 define each cutout. The two end edges correspond to the two equal-length sides of the cutout, respectively. A locking unit (not labeled) of each two adjacent rims 45 includes a buckle 454 and a socket 455.

The socket 455 has a shape of a “T”, and is formed at a center portion of one end edge of each rim 45, from the end edge to the inside of the rim 45. The socket 455 includes a first part (not labeled) and a second part (not labeled) which cooperatively form the “T” shape. The first part is the crossbar part of the “T” shape, and is parallel to the end edge of the rim 45. The second part is the stem part of the “T” shape, and spans from the first part to the cutout at the end edge. The buckle 454 of one rim 45 corresponds to the socket 455 of the adjacent rim 45, and perpendicularly extends from a center portion of the end edge of the rim 45. The buckle 454 includes two parallel, symmetrically opposite elastic elements 456. Each elastic element 456 includes a straight part 458 and a hook 457 integrated with the straight part 458. A bending direction of the hook 457 of one elastic element 456 is symmetrically opposite to a bending direction of the hook 457 of the other elastic element 456. Each two adjacent rims 45 are fixed to each other by latching the buckle 454 of one rim 45 in the socket 455 of the other rim 45. The rims 45 of the first frame 41 have simple structures and can be made conveniently.

It should be pointed out that in alternative embodiments, the first frame is not limited to having four rims. For example, the first frame can include five, six or more rims arranged end to end. Accordingly, the first frame can include five, six or more sidewalls corresponding to the rims 25, 25′, 35, 45, respectively. Furthermore, the rims 25, 25′, 35, 45 can instead have other regular shapes, such as rectangular shapes, or irregular shapes, or a combination of regular shapes and irregular shapes.

It is believed that the present embodiments and their advantages will be understood from the foregoing description, and it will be apparent that various changes may be made thereto without departing from the spirit and scope of the embodiments or sacrificing all of their material advantages.

What is claimed is:

1. A frame comprising:
a plurality of sidewalls; and
a plurality of rims extending substantially perpendicularly from the plurality of sidewalls, respectively, the rims arranged end to end in turn, thereby defining an opening therebetween;
wherein the sidewalls are portions of a single bent metallic strip with two ends thereof connected together.

2. The frame of claim 1, wherein each rim comprises a first portion and a second portion, the first portion being isosceles trapezoidal, a longer inner edge of the first portion adjoining a corresponding sidewall, the second portion being isosceles triangular, and an inmost, oblique edge of the second portion adjoining one of two equal end edges of the first portion.

3. The frame of claim 2, wherein the first portion and the second portion cooperatively define a shape that is substantially a right trapezoid.

4. The frame of claim 2, wherein the second portion is offset from the first portion in a direction perpendicular to the first portion, the direction being opposite to a direction in which the corresponding sidewall extends from the rim.

5. The frame of claim 4, wherein the second portion of each rim overlaps part of the first portion of an adjacent rim.

6. The frame of claim 5, wherein each two adjacent rims are connected by welding the second portion of one rim on the part of the first portion of the other rim.

7. The frame of claim 5, further comprising a plurality of locking units, wherein each locking unit is provided at two adjacent rims where the second portion of one of the rims overlaps part of the first portion of the adjacent rim, each locking unit comprises a positioning hole and a protrusion, the positioning hole being a through hole defined in one of the second portion of one of the rims and the first portion of the adjacent rim, the protrusion provided on the other one of the second portion of one of the rims and the first portion of the adjacent rim, and the protrusion being engagingly received in the positioning hole.

8. The frame of claim 7, wherein an axis of the protrusion is substantially coaxial with an axis of the positioning hole, and each two adjacent rims are fixed to each other by the engaging receipt of the protrusion in the positioning hole.

9. The frame of claim 1, wherein each rim is generally isosceles trapezoidal, a longer inner edge of the rim adjoining a corresponding sidewall.

10. The frame of claim 9, wherein the rims comprise a plurality of locking units, each locking unit is provided at two adjacent rims where the two adjacent rims abut each other, each locking unit comprises a buckle and a socket, the socket formed at an end edge of one of the rims, the buckle formed at an end edge of the other rim, the socket having a “T” shape, the buckle comprising two opposite elastic hooks, and the two adjacent rims being fixed to each other by snapping latching of the hooks of the buckle in the socket.

11. The frame of claim 1, wherein each rim comprises a first portion and two second portions respectively extending from two ends of the first portion, one second portion of each rim overlapping with one second portion of an adjacent rim, and for each rim a thickness of each of the second portions being less than that of the first portion.

12. The frame of claim 11, wherein for each rim the thickness of each of the second portions is approximately half of that of the first portion, the two adjacent second portions of each two adjacent rims overlap and are jointed together, and the combination of the overlapped second portions of each two adjacent rims is substantially coplanar with the corresponding first portions.

13. A method for manufacturing a frame for a liquid crystal display, the method comprising:
forming a rectangular metallic strip;
rolling the metallic strip to form an elongated first plate and an elongated second plate perpendicularly adjoining the first plate;
punching and cutting the first plate to form a plurality of rims, each two adjacent rims defining an opening therebetween;
bending the second plate at points corresponding to the openings, thereby forming a plurality of sidewalls;
connecting each two adjacent rims; and
connecting two ends of the second plate.

14. The method of claim 13, wherein the rectangular metallic strip is substantially the same length as a sum of lengths of the plurality of sidewalls, the rectangular metallic strip has a uniform transverse width substantially the same as a sum of a height of one of the plurality of sidewalls and a transverse width of one of the plurality of rims, and a uniform transverse width of the second plate is the same as a height of one of the plurality of sidewalls.

15. The method of claim 13, wherein after punching and cutting the first portion to form the plurality of rims, each rim comprises a first portion and a second portion, the first portion being isosceles trapezoid and a longer inner edge of the first portion adjoining the second plate, the second portion being isosceles triangular and an inmost, oblique edge of the second portion adjoining one of two equal end edges of the first portion, the first portions and the second portions of the rims arranged alternately along a length of the combined first and second plates, and a cutout being substantially isosceles triangular defined between each two adjacent rims.

16. The method of claim 15, wherein the second portion projects from the first portion via stamping each rim in a direction perpendicular to the first portion, the direction being opposite to an extending direction of the second plate from the rims.

17. The method of claim 15, wherein after bending the second plate, the second portion of each rim closely overlaps a part of the first portion of an adjacent rim, and each two adjacent rims are connected at overlapping portions of each two adjacent rims by laser welding.

18. The method of claim 13, wherein after punching and cutting the first plate to form the plurality of rims, each rim comprises a first portion and two second portions respectively extending from two ends of the first portion, a thickness of each of the two second portions less than that of the first portion, and after bending the second plate, one second portion of each rim overlaps one second portion of an adjacent rim, and the combination of the overlapped second portions of each two adjacent rims substantially coplanar with the corresponding first portions.

19. A liquid crystal display, comprising:
a first frame, comprising a plurality of sidewalls and a plurality of rims extending substantially perpendicularly from the plurality of sidewalls, respectively;
a display panel;
a backlight module; and
a second frame cooperatively with the first frame receiving and fixing the display panel and the backlight module;
wherein the plurality of rims is arranged end to end in turn to define an opening as a display view window of the liquid crystal display, and the sidewalls are portions of a single bent metallic strip with two ends thereof connected together.

20. The liquid crystal display of claim 19, wherein a height of each sidewall substantially equals a thickness of the display panel.
